(19) United States
(12) Patent Application Publication
(10) Pub. No.: US 2005/0272619 A1
(43) Pub. Date: Dec. 8, 2005

(54) Detergent composition

(76) Inventors: Patrice Mark Luc Borgonjon, Mariakerke (BE); Jichun Shi, Liberty Township, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/147,060

(22) Filed: Jun. 7, 2005

Related U.S. Application Data
(60) Provisional application No. 60/577,700, filed on Jun. 7, 2004.

(51) Int. Cl. C11D 3/50

(52) U.S. Cl. 510/101

(57) ABSTRACT

The present invention relates to a detergent composition having viscosity of at least 700 cps, measured using the standard Brookfield viscometer method at 20° C., and comprising from 0.1% to 3% by weight of the composition of an organic salt, inorganic salt or mixtures thereof and from 0.05% to 10% by weight of the composition of a hydrophobic block copolymer having average molecular weight of at least 500 and comprising alkylene oxide moieties.

### TECHNICAL FIELD

The present invention relates to the improvement of dissolution of high viscosity liquid or gel detergent compositions in water. More preferably said invention relates to hand dishwashing compositions.

### BACKGROUND OF THE INVENTION

Liquid or gel detergent compositions are often designed to be used in diluted form wherein the composition as bought by the consumer is either used directly with water or prediluted in a bowl or sink filled with water prior to use. It is therefore necessary that the detergent composition dissolves quickly and efficiently in water. Detergent compositions, hand dishwashing compositions particularly are also often thickened. Thickened compositions have several benefits including: easier dispensing because they permit better control and accuracy of the dispensing process; improved dispersion of the composition over a surface; and improved cling on non-horizontal surfaces. In addition to these technical reasons for using a thickened composition, consumers tend to equate composition thickness with richness and quality of cleaning performance.

Liquid compositions, especially thickened compositions can have problems of poor mixing and dissolution in water. A composition that does not dissolve sufficiently quickly will give poorer cleaning and sudsing performance until the product has dissolved. This is not desirable, especially in the context of hand dishwashing where consumers rely on the appearance of suds to signal that the composition is active. In addition, poorly dissolving compositions do not rinse well from the surface of the dishware, especially glassware, leaving the surface feeling slippery or slimy. It is an object of the present invention to provide a composition which despite having high viscosity, dissolves efficiently and effectively in water.

### SUMMARY OF THE INVENTION

According to the present invention there is provided a detergent composition having viscosity of at least 700 cps, measured using the standard Brookfield viscometer method at 20° C., and comprising from 0.1% to 3% by weight of the composition of an organic salt, inorganic salt or mixtures thereof and from 0.05% to 10% by weight of the composition of a hydrophobic block copolymer having average molecular weight of at least 500 and comprising alkylene oxide moieties.

### DETAILED DESCRIPTION OF THE INVENTION

The compositions of the present invention are preferably suitable for use in cleaning hard surfaces, for example any kind of surfaces typically found in houses like kitchens, bathrooms, or in car interiors or exteriors, e.g., floors, walls, tiles, windows, sinks, showers, shower plastified curtains, wash basins, WCs, dishes, fixtures and fittings and the like made of different materials like ceramic, vinyl, no-wax vinyl, linoleum, melamine, glass, any plastics, plastified wood, metal or any painted or varnished or sealed surface and the like. Hard-surfaces also include household appliances including, but not limited to, refrigerators, freezers, washing machines, automatic dryers, ovens, microwave ovens, dishwashers and so on. More preferably the cleaning composition according to the present invention is suitable for cleaning dishware including dishes, cups, cutlery, glassware, food storage containers, cutlery, cooking utensils, sinks and other kitchen surfaces.

The cleaning composition may be in any suitable form, for example gel or liquid. The cleaning composition is preferably in liquid form. Moreover the cleaning composition is preferably in liquid aqueous form. Where present, water is preferably present at a level of from 30% to 80% by weight of the cleaning composition, more preferably from 40% to 70% and most preferably from 45% to 65%. The composition may have any suitable pH. More preferably the pH of the composition is adjusted to between 4 and 14. Even more preferably the composition has pH of between 7 and 13, most preferably between 7 and 10. The pH of the composition can be adjusted using pH modifying ingredients known in the art.

The compositions of the present invention are preferably thickened and have viscosity of greater than 700 cps, when measured at 20° C. More preferably the viscosity of the composition is between 700 and 100 cps. The present invention excludes compositions which are in the form of microemulsions. Whilst the dissolution aid system of the present invention is specifically designed to aid the dissolution of higher viscosity systems because of the specific dissolution problems, it can also be used in lower viscosity systems.

The compositions of the present invention comprise a dissolution aid system comprising a hydrophobic polymer and an organic and/or inorganic salt. Whilst both ingredients have been used in detergent compositions in the past, the synergistic combination of the two ingredients to provide a dissolution benefit has not previously been described.

Hydrophobic Block Polymer

The hydrophobic block polymer of the present invention is defined as a block polymer having alkylene oxide moieties and average molecular weight of at least 500, but preferably less than 10 000, more preferably from 1000 to 5000 and most preferably from 1500 to 3500.

As is widely known in the art, the hydrophobicity of a polymer refers to its incompatibility with or insolubility in water. Suitable hydrophobic polymers have a water solubility of less than about 1%, preferably less than about 0.5%, more preferably less than about 0.1% by weight at 25° C.

Moreover, suitable hydrophobic polymers may exhibit a CLogP value of greater than about 1, preferably greater than about 2, and more preferably greater than 2.5, but less than about 40, preferably less than about 20, and more preferably less than about 6. In another embodiment, the ClogP value of the hydrophobic polymer in the present composition is from about 2.5 to about 6.

The ClogP value relates to the octanol/water partition coefficient of a material. Specifically, the octanol/water partition coefficient (P) is a measure of the ratio of the concentration of a particular polymer in octanol and in water at equilibrium. The partition coefficients are reported in logarithm of base 10 (i.e., logP). The logP values of many materials have been reported in the Pomona92 database, available from Daylight Chemical Information Systems, Inc. (hereinafter “Daylight CIS”), along with citations to the original literature. However, the logP values are most conveniently calculated by several “CLogP” programs widely available. For example, Daylight CIS has a “CLogP” program available. The United States Environmental Protection Agency also has available an Estimation Programs Interface for Windows (EPI-Win) that can be used to calculate the CLogP (or Log Kow). These programs also list experimental logP values when they are available in their respective databases. The preferred calculation tool is the EPI-Win model to calculate CLogP or LogKow based on polymer structures, primarily due to its versatility and user friendliness.

The “calculated logP” (ClogP) may be determined by the fragment approach of Hansch and Leo (cf., A. Leo, in Comprehensive Medicinal Chemistry, Vol. 4, C. Hansch, P. G. Sammens, J. B. Taylor and C. A. Ransden, Eds., p. 295, Pergamon Press, 1990). The fragment approach is based on the chemical structure of each molecule, taking into account the numbers and types of atoms, the atom connectivity, and chemical bonding. Other methods that may be used to compute ClogP include, e.g., Crippen's fragmentation method as disclosed in J. Chem. Inf. Comput. Sci., 27a, 21 (1987); Viswanadhan's fragmentation method as disclosed in J. Chem. Inf. Comput. Sci., 29, 163 (1989); and Broto's method as disclosed in Eur. J. Med. Chem.—Chim. Theor., 19, 71 (1984). It is understood by those skilled in the art that while experimental log P values could also be used, they represent a less preferred embodiment of the invention. When experimental log P values are used, the log P values at one hour are preferred.

“Block polymers” as used herein is meant to encompass polymers including two or more different homopolymeric and/or monomeric units which are linked to form a single polymer molecule. Typically, the block polymers are in the form of di-, tri- and multi-block polymers. Tri-block polymers have the basic structure ABA, wherein A and B are different homopolymeric and/or monomeric units. Di-block polymers are those having the basic structure ABAB, again wherein A and B are different homopolymeric and/or monomeric units. Those skilled in the art will recognize the phrase “block copolymers” is synonymous with this definition of “block polymers”.

“Building Blocks” herein is meant homopolymeric units and/or monomeric units that polymerize with one another to form block copolymers. Suitable building blocks in accordance with the present invention are alkylene oxide moieties. The different homopolymeric units present in block polymers retain some of their respective individual, original properties even though they are linked to one or more different homopolymeric units. Block polymers are known to exhibit properties that are different from those of homopolymers, random copolymers, and polymer blends. The properties of block copolymers themselves also differ depending on the length and chemical composition of the blocks making up the block polymer. Accordingly, the properties of a block polymer are influenced by the arrangement of the blocks within the block polymer. For example, a polymer such as:
hydrophobic block-hydrophilic block-hydrophobic block
   will exhibit properties that are different than a block polymer such as:
hydrophilic block-hydrophobic block-hydrophilic block.

Preferred copolymers comprise ethylene oxide as one of the monomeric units. More preferred copolymers are those with ethylene oxide and propylene oxide. The ethylene oxide content of such preferred polymers is more than about 5%, and more preferably more than about 8%, but less than about 50%, and more preferably less than about 30%. A preferred polymer is ethylene oxide/propylene oxide copolymer available from BASF under the tradename Pluronic. Of those materials, Pluronic L81 is a specifically preferred polymer having an average molecular weight of 2750 and comprising on average 10% ethylene oxide and 90% propylene oxide units (according to supplier specifications). Another preferred polymer has an average molecular weight of 1750 and comprises on average 30% ethylene oxide and 70% propylene oxide units.

Preferred examples of such polymers are copolymeric glycols comprising alkylene oxide moieties preferably selected from combinations of ethylene oxide (EO), propylene oxide (PrO), butylene oxide (BO), pentylene oxide (PeO) and hexylene oxide (HO) moieties. However where ethylene oxide moieties are present they are preferably present in combination with another more hydrophobic moiety, for example propylene oxide or butylene oxide. Preferred copolymers are formed by adding blocks of polyethylene oxide moieties to the ends of polyalkylene glycol chains, with initiators that are commonly used for this reaction as known in the art. The preparation of block polymers is well known to polymer manufacturers and is not the subject of the present invention.

Preferred copolymers are readily biodegradable under aerobic conditions. Aerobic biodegradation is measured by the production of carbon dioxide (CO₂) from the test material in the standard test method as defined by Method 301B test guidelines of the Organization for Economic Cooperation and Development (OECD). The preferred polymers should achieve at least 60% of biodegradation as measured by CO₂ production in 28 days in the standard Method 301B. These OECD test method guidelines are well know in the art and cited herein as a reference (OECD, 1986).

Preferred copolymers comprise ethylene oxide as one of the monomeric units. More preferred copolymers are those with ethylene oxide and propylene oxide. A preferred polymer is ethylene oxide/propylene oxide copolymer available from BASF under the tradename Pluronic. Of those materials, Pluronic L81 is a specifically preferred polymer having an average molecular weight of ˜2750 and comprising on average 10% ethylene oxide and 90% propylene oxide units (according to supplier specifications).

Although not wishing to be bound by theory, it is believed that the hydrophobic block polymers of the present invention provide a dissolution benefit in two ways. Firstly the hydrophobic polymers are believed to be able to prevent the formation of viscous hexagonal liquid crystal surfactant phases upon dilution in water. The polymers are able to effectively interact with the ordered and structured hydrophobic tails of the surfactant bilayer, disrupting the bilayer and promoting the formation of isotropic low-viscosity surfactant phases. Secondly, it is believed that the hydrophobic co-polymers can also behave in a similar way to traditional hydrotopes, such as sodium cumene sulphonate (SCS). The hydrophobic area of the polymer is attracted to the hydrophobic tail(s) of the surfactant, and the hydrophilic area of the polymer to the hydrophilic head(s). Such attraction and interaction masks the surfactants hydrophobicity and promotes solubility. Random polymers do not act in the same way because they don't have well-defined hydrophobic and hydrophilic regions.

Hydrophobic block polymers are preferably present in the composition at more than 0.05%, more preferably at least 0.1%, most preferably at least 0.2% by weight of the composition. The composition will also preferably contain no more than 10%, more preferably no more than 5%, most preferably no more than 3% by weight of the composition of hydrophobic polymer.

Organic and Inorganic Salts

The present composition also comprises a short-chain organic salt, inorganic salt or mixtures thereof. Said short-chain organic salts can be either aliphatic salts or aromatic salts or mixtures hereof and is preferably selected from the group consisting of alkali metal salt and/or alkali earth metal salts of short-chain alkyl-or aryl carboxylic acids comprising a hydrocarbyl chain of no more than 7 carbons. Most preferably the organic salt is sodium citrate. Said inorganic salts are selected from the group consisting an alkali metal salt and/or alkali earth metal salts of halides, with the most preferred being sodium chloride.

Said organic or inorganic salt is preferably present in the composition at a level of from 0.1 to 5%, more preferably from 0.5 to 3%, and most preferably from 0.8 to 1.5% by weight of the composition.

Viscosity Test Method

The viscosity of the composition of the present invention is measured on a Brookfield viscometer model # LVDVII+ at 20° C. The spindle used for these measurements is S31 with the appropriate speed to measure products of different viscosities; e.g., 12 rpm to measure products of viscosity greater than 1000 cps; 30 rpm to measure products with viscosities between 500 cps-1000 cps; 60 rpm to measure products with viscosities less than 500 cps.

Dynamic Dissolution Test (DDT)

The DDT allows the user to determine the dissolution profile, in percentage, over time for a given detergent composition using conductivity monitoring, under fixed test conditions. The following equipment is required to perform the DDT:

An Overhead stirrer, for example RW20DZM.n from IKA labortechnik

A 4 blade mixer, also available from IKA laortechnik

5000 mL glass beaker

5 mL glass pipettes with a 3 valve rubber pipette pump

Conductimeter LF340A/set from WTW with temperature measuring capability

A steel 400 g cylindrical weight diameter 50 mm height 28 mm

At least 4 L of demineralised water per replicate of the test at 20° C.

Procedure:

Set overhead mixer at 90 RPM (±1) and switch it off afterwards. Place the cylindrical weight in the bottom centre of the beaker. Fill the beaker up to the 4 liters mark precisely. Place the beaker under the overhead stirrer, plunge the four blade mixer into the water to a depth of 5 cm, making sure that the mixer is right in the middle of the beaker (aligned with cylindrical weight). Place the conductivity probe into the water to a depth of 4 cm (the probe must be entirely in the water) and close to the beaker wall (approx 1 cm between probe and wall). Measure the conductivity of the water: this must be below 5 μS/cm.

Remove a 5 mL sample of the detergent composition to be tested using a 5 mL glass pipette and the rubber pump. Wipe the pipette with paper to remove excess detergent composition from the outside wall. Plunge the pipette into the beaker of water and deliver the composition gently on the bottom of the beaker (use always the same spot—mark it, half way between cylindrical piece and beaker wall). Start the overhead stirrer and conductimeter simultaneously immediately after introduction of the composition. Set the conductimeter to take measurements at intervals of 5 seconds. End the test when the conductivity reading is steady for 20 seconds.

Subtract the initial conductivity value (for demineralised water) from each data point of the test, such that initial conductivity is set a zero. Set the end point conductivity value at 100%, then calculate the percentage dissolution for each data point from the set knowing end-point conductivity value is 100%. The data points described in the table below are the time taken to reach 70% and 90% dissolution of the composition

Compositions were prepared according to the present invention, the initial viscosity (100% product) and the dynamic dissolution times (DDT) at 70% and 90% dissolution in water were measured.

| | Initial | 70% Dynamic | 90% Dynamic |
|---|---|---|---|
| Product | Viscosity | Dissolution Time | Dissolution Time |
| Composition A | 650 cps | 28 seconds | 58 seconds |
| Composition B | 970 cps | 34 seconds | 57 seconds |
| Composition C | 900 cps | 31 seconds | 69 seconds |
| Composition D | 900 cps | 50 seconds | 81 seconds |

The following examples, whilst being representative of the compositions of the present invention are in no way meant to be limiting.

Composition

| | A | B | C | D |
|---|---|---|---|---|
| Pluronic L81 | 0 | 1.0 | 0.5 | 0 |
| Poly(oxyethylene | 0 | 0 | 0 | 1.5 |
| oxyhexylene) random | | | | |
| copolymer | | | | |
| Sodium Citrate.2H2O | 0 | 0 | 1.0 | 0 |
| SCS ¹ | 1.8 | 0 | 0 | 0 |
| PolyPropylene Glycol 2000 | 0.8 | 0 | 0 | 0 |
| Ethanol | 2.5 | 2.0 | 2.8 | 2.5 |
| NaCl | 1.4 | 1.0 | 0.8 | 1.0 |
| Amine Oxide ² | 6.0 | 6.0 | 6.5 | 6.5 |
| Nonionic ³ | 2.0 | 2.0 | 2.0 | 2.0 |
| Anionic (AE0.6S) ⁴ | 26.5 | 26.5 | 29 | 26.5 |
| 1,3 BAC ⁵ | 0.5 | 0.5 | 0.5 | 0.5 |
| Suds boosting polymer ⁶ | 0.2 | 0.2 | 0.2 | 0.2 |
| protease ⁷ | | | | |
| water to balance | | | | |
| pH @ 10% | 9 | 9 | 9 | 9 |

¹ Sodium Cumene Sulphonate
² C₁₂-C₁₄ Amine oxide.
³ Nonionic may be either C11 Alkyl ethoxylated surfactant containing 9 ethoxy groups or or C10 Alkyl ethoxylated surfactant containing 8 ethoxy groups.
⁴ C12-13 alkyl ethoxy sulfonate containing an average of 0.6 ethoxy groups.
⁵ 1,3, BAC is 1,3 bis(methylamine)-cyclohexane.
⁶ (N,N-dimethylamino)ethyl methacrylate homopolymer
⁷ The protease is selected from: Savinase ®; Maxatase ®; Maxacal ®; Maxapem 15 ®; subtilisin BPN and BPN′; Protease B; Protease A; Protease D; Primase ®; Durazym ®; Opticlean ®; and Optimase ®; and Alcalase ®.

As can be seen from the example compositions above, composition B and C dissolve in water at about the same rate as composition A, based on the dynamic dissolution test, even though their initial viscosity is much higher. Composition B utilized only the hydrophobic copolymer Pluronic L81, while composition C utilized a combination of Pluronic L81 and organic salt sodium citrate. Both of these compositions did not contain the traditional hydrotrope sodium cumene sulfonate (SCS). Furthermore, composition C demonstrates the synergistic benefit of Pluronic L81+sodium citrate. In this case, only a considerably lower amount of hydrophobic polymer is needed to achieve a similar dynamic dissolution rate in water for the high viscosity product.

Composition D dissolves much slower than composition B and C, even though it utilized a higher level of a random hydrophobic polyoxyalkylene polymer. This indicates that the traditional hydrotrope SCS is required for the random hydrophobic polymers to achieve satisfactory dissolution rate of the high viscosity liquid hand dish detergent products.

| | System | | |
|---|---|---|---|
| | E | F | G |
| sodium citrate.2H2O | / | 1.5% | 1.0% |
| EO:PO Copolymer | 1.5% | / | 0.5% |
| pluronic L81 | | | |
| NaCl | 0.8% | 0.8% | 0.8% |
| Sum of dissolution | 2.3% | 2.3% | 2.3% |
| aid | | | |
| Viscosity | Target 900 cps | Target 900 cps | Target 900 cps |
| Brookfield | | | |
| viscometer | Actual 885 cps | Actual 892 cps | Actual 870 cps |
| at 20° C. | | | |
| Dissolution DDT | 128/202 | 41/90 | 33/70 |
| 70/90 | | | |

System E comprises hydrophobic copolymer and NaCl. It shows poor dissolution by comparison to compositions F and G. System F comprises sodium citrate.2H₂O and NaCl and still shows poor dissolution. Moreover this composition requires ethanol in order to reach target viscosity. We are not discussing ethanol level in this debate, but system E and G comprise 3% ethanol whilst system F requires 5.5% ethanol in order to meet the target viscosity. System G is a composition according to the present invention and shows good dissolution and clearly proves the synergy of the hydrophobic polymer and salt.

Optional Ingredients

The compositions of the present invention may also comprise optional ingredients for example surfactant, hydrotrope, viscosity modifier, diamine, surfactants, polymeric suds stabiliser, enzymes, builder, perfume, chelating agent and mixtures thereof.

All parts, percentages and ratios used herein are expressed as percent weight unless otherwise specified. All documents cited are, in relevant part, incorporated herein by reference.

Surfactant

The compositions of the present invention preferably comprise a surfactant. Surfactants may be selected from the group consisting of amphoteric, zwitterionic, nonionic, anionic, cationic surfactants and mixtures thereof. Suitable such surfactants are those commonly used in detergent compositions.

Preferred amphoteric surfactants useful in the present invention are selected from amine oxide surfactants. Amine oxides are semi-polar nonionic surfactants and include water-soluble amine oxides containing one alkyl moiety of from 10 to 18 carbon atoms and 2 moieties selected from the group consisting of alkyl groups and hydroxyalkyl groups containing from 1 to 3 carbon atoms; water-soluble phosphine oxides containing one alkyl moiety of from 10 to 18 carbon atoms and 2 moieties selected from the group consisting of alkyl groups and hydroxyalkyl groups containing from 1 to 3 carbon atoms; and water-soluble sulfoxides containing one alkyl moiety of from 10 to 18 carbon atoms and a moiety selected from the group consisting of alkyl and hydroxyalkyl moieties of from 1 to 3 carbon atoms. Preferred amine oxide surfactants in particular include C₁₀-C₁₈ alkyl dimethyl amine oxides and C₈-C₁₂ alkoxy ethyl dihydroxy ethyl amine oxides.

Other suitable, non-limiting examples of amphoteric detergent surfactants that are useful in the present invention include amido propyl betaines and derivatives of aliphatic or heterocyclic secondary and ternary amines in which the aliphatic moiety can be straight chain or branched and wherein one of the aliphatic substituents contains from 8 to 24 carbon atoms and at least one aliphatic substituent contains an anionic water-solubilizing group. Preferably the amphoteric surfactant where present, is present in the composition in an effective amount, more preferably from 0.1% to 20%, even more preferably 0.1% to 15%, even more preferably still from 0.5% to 10%,by weight.

Suitable nonionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly preferred are the condensation products of alcohols having an alkyl group containing from 10 to 20 carbon atoms with from 2 to 18 moles of ethylene oxide per mole of alcohol. The preferred alkylpolyglycosides have the formula R²O(CₙH₂ₙO)ₜ(glycosyl)ₓ, wherein R² is selected from the group consisting of alkyl, alkyl-phenyl, hydroxyalkyl, hydroxyalkylphenyl, and mixtures thereof in which the alkyl groups contain from 10 to 18, preferably from 12 to 14, carbon atoms; n is 2 or 3, preferably 2; t is from 0 to 10, preferably 0; and x is from 1.3 to 10, preferably from 1.3 to 3, most preferably from 1.3 to 2.7. The glycosyl is preferably derived from glucose. To prepare these compounds, the alcohol or alkylpolyethoy alcohol is formed first and then reacted with glucose, or a source of glucose, to form the glucoside (attachment at the 1-position). The additional glycosyl units can then be attached between their 1-position and the preceding glycosyl units 2-, 3-, 4- and/or 6-position, preferably predominantly the 2-position.

Fatty acid amide surfactants having the formula:

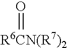

wherein R⁶ is an alkyl group containing from 7 to 21 (preferably from 9 to 17) carbon atoms and each R⁷ is selected from the group consisting of hydrogen, C₁-C₄ alkyl, C₁-C₄ hydroxyalkyl, and —(C²H₄O)ₓH where x varies from 1 to 3. Preferred amides are C₈-C₂₀ ammonia amides, monoethanolamides, diethanolamides, and isopropanolamides.

Preferably the nonionic surfactant, when present in the composition, is present in an effective amount, more preferably from 0.1% to 20%, even more preferably 0.1% to 15%, even more preferably still from 0.5% to 10%,by weight.

Anionic surfactants are preferred components of the compositions of the present invention. Suitable anionic surfactants for use in the compositions herein include water-soluble salts or acids of C₆-C₂₀ linear or branched hydrocarbyl, preferably an alkyl, hydroxyalkyl or alkylaryl, having a C₁₀-C₂₀ hydrocarbyl component, more preferably a C₁₀-C₁₄ alkyl or hydroxyalkyl, sulphate or sulphonates. SySuitable counterions include H, alkali metal cation or ammonium or substituted ammonium, but preferably sodium.

Where the hydrocarbyl chain is branched, it preferably comprises C1-4 alkyl branching units. The average percentage branching of the anionic surfactant is preferably greater than 30%, more preferably from 35% to 80% and most preferably from 40% to 60%.

The anionic surfactant is preferably present at a level of at least 15%, more preferably from 20% to 40% and most preferably from 25% to 40% by weight of the total composition.

Viscosity Modifier

The present compositions may preferably comprise a viscosity modifier. Suitable viscosity modifiers include lower alkanols, glycols, C4-14 ethers and diethers, glycols or alkoxylated glycols, alkoxylated aromatic alcohols, aromatic alcohols, aliphatic branched alcohols, alkoxylated aliphatic branched alcohols, alkoxylated linear C1-C5 alcohols, linear C1-C5 alcohols, amines, C8-C14 alkyl and cycloalkyl hydrocarbons and halohydrocarbons, C6-C16 glycol ethers and mixtures thereof.

Preferred viscosity modifiers are selected from methoxy octadecanol, ethoxyethoxyethanol, benzyl alcohol, 2-ethylbutanol and/or 2-methylbutanol, 1-methylpropoxyethanol and/or 2-methylbutoxyethanol, linear C1-C₅ alcohols such as methanol, ethanol, propanol, isopropanol, butyl diglycol ether (BDGE), butyltriglycol ether, ter amilic alcohol, glycerol and mixtures thereof. Particularly preferred viscosity modifiers which can be used herein are butoxy propoxy propanol, butyl diglycol ether, benzyl alcohol, butoxypropanol, propylene glycol, glycerol, ethanol, methanol, isopropanol and mixtures thereof.

Other suitable viscosity modifiers for use herein include propylene glycol derivatives such as n-butoxypropanol or n-butoxypropoxypropanol, water-soluble CARBITOL R viscosity modifiers or water-soluble CELLOSOLVE R viscosity modifiers; water-soluble CARBITOL R viscosity modifiers are compounds of the 2-(2-alkoxyethoxy)ethanol class wherein the alkoxy group is derived from ethyl, propyl or butyl; a preferred water-soluble carbitol is 2-(2-butoxyethoxy)ethanol also known as butyl carbitol. Water-soluble CELLOSOLVE R viscosity modifiers are compounds of the 2-alkoxyethoxy ethanol class, with 2-butoxyethoxyethanol being preferred. Other suitable viscosity modifiers include benzyl alcohol, and diols such as 2-ethyl-1,3-hexanediol and 2,2,4-trimethyl-1,3-pentanediol and mixtures thereof. Some preferred viscosity modifiers for use herein are n-butoxypropoxypropanol, BUTYL CARBITOL 6 and mixtures thereof.

The viscosity modifiers can also be selected from the group of compounds comprising ether derivatives of mono-, di- and tri-ethylene glycol, butylene glycol ethers, and mixtures thereof. The molecular weights of these viscosity modifiers are preferably less than 350, more preferably between 100 and 300, even more preferably between 115 and 250. Examples of preferred viscosity modifiers include, for example, mono-ethylene glycol n-hexyl ether, mono-propylene glycol. n-butyl ether, and tri-propylene glycol methyl ether. Ethylene glycol and propylene glycol ethers are commercially available from the Dow Chemical Company under the tradename “Dowanol” and from the Arco Chemical Company under the tradename “Arcosolv”. Other preferred viscosity modifiers including mono- and di-ethylene glycol n-hexyl ether are available from the Union Carbide company.

When present the composition will preferably contain at least 0.01%, more preferably at least 0.5%, even more preferably still, at least 1% by weight of the composition of viscosity modifier. The composition will also preferably contain no more than 20%, more preferably no more than 10%.

These viscosity modifiers may be used in conjunction with an aqueous liquid carrier, such as water, or they may be used without any aqueous liquid carrier being present. Viscosity modifiers are broadly defined as compounds that are liquid at temperatures of 20° C.-25° C. and which are not considered to be surfactants. One of the distinguishing features is that viscosity modifiers tend to exist as discrete entities rather than as broad mixtures of compounds.

Diamines

Another optional although preferred ingredient of the compositions according to the present invention is a diamine. Since the habits and practices of the users of detergent compositions show considerable variation, the composition will preferably contain at least 0.1%, more preferably at least 0.2%, even more preferably, at least 0.25%, even more preferably still, at least 0.5% by weight of said composition of diamine. The composition will also preferably contain no more than 15%, more preferably no more than 10%, even more preferably, no more than 6%, even more preferably, no more than 5%, even more preferably still, no more than about 1.5% by weight of said composition of diamine.

Preferred organic diamines are those in which pK1 and pK2 are in the range of 8.0 to 11.5, preferably in the range of 8.4 to 11, even more preferably from 8.6 to 10.75. Preferred materials for performance and supply considerations are 1,3-bis(methylamine)-cyclohexane (pKa=10 to 10.5), 1,3 propane diamine (pK1=10.5; pK2=8.8), 1,6 hexane diamine (pK1=11; pK2=10), 1,3 pentane diamine (Dytek EP) (pK1=10.5; pK2=8.9), 2-methyl 1,5 pentane diamine (Dytek A) (pK1=11.2; pK2=10.0). Other preferred materials are the primary/primary diamines with alkylene spacers ranging from C4 to C8. In general, it is believed that primary diamines are preferred over secondary and tertiary diamines.

Definition of pK1 and pK2—As used herein, “pKa1” and “pKa2” are quantities of a type collectively known to those skilled in the art as “pKa” pKa is used herein in the same manner as is commonly known to people skilled in the art of chemistry. Values referenced herein can be obtained from literature, such as from “Critical Stability Constants: Volume 2, Amines” by Smith and Martel, Plenum Press, NY and London, 1975. Additional information on pKa's can be obtained from relevant company literature, such as information supplied by Dupont, a supplier of diamines. As a working definition herein, the pKa of the diamines is specified in an all-aqueous solution at 25° C. and for an ionic strength between 0.1 to 0.5 M.

Carboxylic Acid

The compositions according to the present invention may comprise a linear or cyclic carboxylic acid or salt thereof to improve the rinse feel of the composition. The presence of anionic surfactants, especially when present in higher amounts in the region of 15-35% by weight of the composition, results in the composition imparting a slippery feel to the hands of the user and the dishware. This feeling of slipperiness is reduced when using the carboxylic acids as defined herein i.e. the rinse feel becomes draggy.

Carboxylic acids useful herein include C1-6 linear or at least 3 carbon containing cyclic acids. The linear or cyclic carbon-containing chain of the carboxylic acid or salt thereof may be substituted with a substituent group selected from the group consisting of hydroxyl, ester, ether, aliphatic groups having from 1 to 6, more preferably 1 to 4 carbon atoms and mixtures thereof.

Preferred carboxylic acids are those selected from the group consisting of salicylic acid, maleic acid, acetyl salicylic acid, 3 methyl salicylic acid, 4 hydroxy isophthalic acid, dihydroxyfumaric acid, 1,2,4 benzene tricarboxylic acid, pentanoic acid and salts thereof and mixtures thereof. Where the carboxylic acid exists in the salt form, the cation of the salt is preferably selected from alkali metal, alkaline earth metal, monoethanolamine, diethanolamine or triethanolamine and mixtures thereof.

The carboxylic acid or salt thereof is preferably present at the level of from 0.1% to 5%, more preferably from 0.2% to 1% and most preferably from 0.25% to 0.5%.

Polymeric Suds Stabilizer

The compositions of the present invention may optionally contain a polymeric suds stabilizer. These polymeric suds stabilizers provide extended suds volume and suds duration without sacrificing the grease cutting ability of the liquid detergent compositions. These polymeric suds stabilizers are selected from:
i) homopolymers of (N,N-dialkylamino)alkyl acrylate esters having the formula: 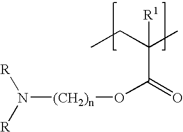
wherein each R is independently hydrogen, C1-C₈ alkyl, and mixtures thereof, R¹ is hydrogen, C₁-C₆ alkyl, and mixtures thereof, n is from 2 to 6; and
ii) copolymers of (i) and

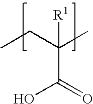

wherein R¹ is hydrogen, C1-C6 alkyl, and mixtures thereof, provided that the ratio of (ii) to (i) is from 2 to 1 to 1 to 2; The molecular weight of the polymeric suds boosters, determined via conventional gel permeation chromatography, is from 1,000 to 2,000,000, preferably from 5,000 to 1,000,000, more preferably from 10,000 to 750,000, more preferably from 20,000 to 500,000, even more preferably from 35,000 to 200,000. The polymeric suds stabilizer can optionally be present in the form of a salt, either an inorganic or organic salt, for example the citrate, sulfate, or nitrate salt of (N,N-dimethylamino)alkyl acrylate ester.

One preferred polymeric suds stabilizer is (N,N-dimethylamino)alkyl acrylate esters, namely

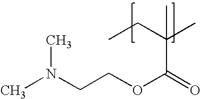

When present in the compositions, the polymeric suds booster may be present in the composition from 0.01% to 15%, preferably from 0.05% to 10%, more preferably from 0.1% to 5%, by weight.

Builder

The compositions according to the present invention may further comprise a builder system. If it is desirable to use a builder, then any conventional builder system is suitable for use herein including aluminosilicate materials, silicates, polycarboxylates and fatty acids, materials such as ethylene-diamine tetraacetate, metal ion sequestrants such as aminopolyphosphonates, particularly ethylenediamine tetramethylene phosphonic acid and diethylene triamine pentamethylene-phosphonic acid. Though less preferred for obvious environmental reasons, phosphate builders can also be used herein.

Suitable polycarboxylates builders for use herein include citric acid, preferably in the form of a water-soluble salt, derivatives of succinic acid of the formula R—CH(COOH)CH₂(COOH) wherein R is C₁₀-₂₀ alkyl or alkenyl, preferably C₁₂₋₁₆, or wherein R can be substituted with hydroxyl, sulfo sulfoxyl or sulfone substituents. Specific examples include lauryl succinate, myristyl succinate, palmityl succinate 2-dodecenylsuccinate, 2-tetradecenyl succinate. Succinate builders are preferably used in the form of their water-soluble salts, including sodium, potassium, ammonium and alkanolammonium salts.

Other suitable polycarboxylates are oxodisuccinates and mixtures of tartrate monosuccinic and tartrate disuccinic acid such as described in U.S. Pat. No. 4,663,071.

Especially for the liquid execution herein, suitable fatty acid builders for use herein are saturated or unsaturated C₁₀₋₁₈ fatty acids, as well as the corresponding soaps. Preferred saturated species have from 12 to 16 carbon atoms in the alkyl chain. The preferred unsaturated fatty acid is oleic acid. Other preferred builder system for liquid compositions is based on dodecenyl succinic acid and citric acid.

If detergency builder salts are included, they will be included in amounts of from 0.5% to 50% by weight of the composition preferably from 0.5% to 25% and most usually from 0.5% to 5% by weight.

Enzymes

Detergent compositions of the present invention may further comprise one or more enzymes which provide cleaning performance benefits. Said enzymes include enzymes selected from cellulases, hemicellulases, peroxidases, proteases, gluco-amylases, amylases, lipases, cutinases, pectinases, xylanases, reductases, oxidases, phenoloxidases, lipoxygenases, ligninases, pullulanases, tannases, pentosanases, malanases, β-glucanases, arabinosidases or mixtures thereof. A preferred combination is a detergent composition having a cocktail of conventional applicable enzymes like protease, amylase, lipase, cutinase and/or cellulase. Enzymes when present in the compositions, at from 0.0001% to 5% of active enzyme by weight of the detergent composition. Preferred proteolytic enzymes, then, are selected from the group consisting of Alcalase® (Novo Industri A/S), BPN′, Protease A and Protease B (Genencor), and mixtures thereof. Protease B is most preferred. Preferred amylase enzymes include TERMAMYL®, DURAMYL® and the amylase enzymes those described in WO 9418314 to Genencor International and WO 9402597 to Novo.

Maginesium Ions

The presence of magnesium ions in the detergent composition offers several benefits. Notably, the inclusion of such divalent ions improves the cleaning of greasy soils for various hand dishwashing liquid compositions, in particular compositions containing alkyl ethoxy carboxylates and/or polyhydroxy fatty acid amide. This is especially true when the compositions are used in softened water that contains few divalent ions. Preferably, the magnesium ions are added as a hydroxide, chloride, acetate, sulfate, formate, oxide or nitrate salt to the compositions of the present invention.

If they are to be included in an alternate embodiment of the present compositions, then the magnesium ions are present at an active level of from 0.01% to 1.5%, preferably from 0.015% to 1%, more preferably from 0.025% to 0.5%, by weight.

Chelating Agents

The detergent compositions herein may also optionally contain one or more iron and/or manganese chelating agents. Such chelating agents can be selected from the group consisting of amino carboxylates, amino phosphonates, polyfunctionally-substituted aromatic chelating agents and mixtures therein, all as hereinafter defined. Without intending to be bound by theory, it is believed that the benefit of these materials is due in part to their exceptional ability to remove iron and manganese ions from washing solutions by formation of soluble chelates.

Amino carboxylates useful as optional chelating agents include ethylene diamine tetracetates, N-hydroxy ethyl ethylene diamine triacetates, nitrilo-tri-acetates, ethylenediamine tetraproprionates, triethylene tetraamine hexacetates, diethylene triamine pentaacetates, and ethanol diglycines, alkali metal, ammonium, and substituted ammonium salts therein and mixtures therein.

Amino phosphonates are also suitable for use as chelating agents in the compositions of the invention when at lease low levels of total phosphorus are permitted in detergent compositions, and include ethylene diamine tetrakis (methylene phosphonates) as DEQUEST. Preferred, these amino phosphonates to not contain alkyl or alkenyl groups with more than 6 carbon atoms. Polyfunctionally-substituted aromatic chelating agents are also useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene. A preferred biodegradable chelator for use herein is ethylenediamine disuccinate (“EDDS”), especially the [S,S]isomer as described in U.S. Pat. No. 4,704,233, Nov. 3, 1987, to Hartman and Perkins. The compositions herein may also contain water-soluble methyl glycine diacetic acid (MGDA) salts (or acid form) as a chelant or co-builder. Similarly, the so called “weak” builders such as citrate can also be used as chelating agents.

If utilized, these chelating agents will generally comprise from 0.00015% to 15% by weight of the detergent compositions herein. More preferably, if utilized, the chelating agents will comprise from 0.0003% to 3.0% by weight of such compositions.

Other Ingedients—The detergent compositions will further preferably comprise one or more detersive adjuncts selected from the following: soil release polymers, polymeric dispersants, polysaccharides, abrasives, bactericides and other antimicrobials, tarnish inhibitors, dyes, buffers, antifungal or mildew control agents, insect repellents, perfumes, hydrotropes, thickeners, processing aids, suds boosters, brighteners, anti-corrosive aids, stabilizers antioxidants and chelants. A wide variety of other ingredients useful in detergent compositions can be included in the compositions herein, including other active ingredients, carriers, antioxidants, processing aids, dyes or pigments, solvents for liquid formulations, solid fillers for bar compositions, etc. If high sudsing is desired, suds boosters such as the C₁₀-C₁₆ alkanolamides can be incorporated into the compositions, typically at 1%-10% levels. The C₁₀-C₁₄ monoethanol and diethanol amides illustrate a typical class of such suds boosters. Use of such suds boosters with high sudsing adjunct surfactants such as the amine oxides, betaines and sultaines noted above is also advantageous.

An antioxidant can be optionally added to the detergent compositions of the present invention. They can be any conventional antioxidant used in detergent compositions, such as 2,6-di-tert-butyl-4-methylphenol (BHT), carbamate, ascorbate, thiosulfate, monoethanolamine(MEA), diethanolamine, triethanolamine, etc. It is preferred that the antioxidant, when present, be present in the composition from 0.001% to 5% by weight.

Various detersive ingredients employed in the present compositions optionally can be further stabilized by absorbing said ingredients onto a porous hydrophobic substrate, then coating said substrate with a hydrophobic coating. Preferably, the detersive ingredient is admixed with a surfactant before being absorbed into the porous substrate. In use, the detersive ingredient is released from the substrate into the aqueous washing liquor, where it performs its intended detersive function.

To illustrate this technique in more detail, a porous hydrophobic silica (trademark SIPERNAT D10, DeGussa) is admixed with a proteolytic enzyme solution containing 3%-5% of C₁₃₋₁₅ ethoxylated alcohol (EO 7) nonionic surfactant. Typically, the enzyme/surfactant solution is 2.5× the weight of silica. The resulting powder is dispersed with stirring in silicone oil (various silicone oil viscosities in the range of 500-12,500 can be used). The resulting silicone oil dispersion is emulsified or otherwise added to the final detergent matrix. By this means, ingredients such as the aforementioned enzymes, bleaches, bleach activators, bleach catalysts, photoactivators, dyes, fluorescers, fabric conditioners and hydrolyzable surfactants can be “protected” for use in detergents, including liquid laundry detergent compositions.

Process of Cleaning Dishware

The present invention also relates to a process for cleaning dishware. The dishware is contacted with a composition as described above. The composition may be applied to the dishware neat or in dilute form. Thus the dishware may be cleaned singly by applying the composition to the dishware and optionally but preferably subsequently rinsing before drying. Alternatively, the composition can be mixed with water in a suitable vessel, for example a basin, sink or bowl and thus a number of dishes can be cleaned using the same composition and water (dishwater). In a further alternative process the product can be used in dilute form in a suitable vessel as a soaking medium for, typically extremely dirty, dishware. As before the dishware can be optionally, although preferably, rinsed before allowing to dry. Drying make take place passively by allowing for the natural evaporation of water or actively using any suitable drying equipment, for example a cloth or towel.

All documents cited in the DETALED DESCRIPTION OF THE INVENTION are, in relevant part, incorporated herein by reference; the citation of any document is not to be construed as an admission that it is prior art with respect to the present invention

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A detergent composition having viscosity of at least 700 cps, measured using the standard Brookfield viscometer method at 20° C., and comprising from about 0.1% to about 3% by weight of the composition of an organic salt, inorganic salt or mixtures thereof and from about 0.05% to about 10% by weight of the composition of a hydrophobic block copolymer having average molecular weight of at least 500 and comprising alkylene oxide moieties.

2. A detergent composition according to claim 1 wherein the organic salt is selected from the group consisting of alkali metal salt, alkali earth metal salts of short-chain alkyl or aryl carboxylic acids having hydrocarbyl chains containing no more than about 7 carbons and mixtures thereof.

3. A detergent composition according to claim 2 wherein the organic salt is sodium citrate.

4. A detergent composition according to claim 1 wherein the hydrophobic block copolymer has average molecular weight of greater than about 1500, but less than about 3,500.

5. A detergent composition according to claim 1 wherein the hydrophobic block copolymer consists of polyethylene glycol and other polyalkylene glycols selected from the group containing propylene oxide (PrO), butylene oxide (BO), pentylene oxide (PeO) and hexylene oxide (HO) moieties.

6. A detergent composition according to claim 1 wherein the hydrophobic block copolymer has water solubility of less than about 1% by weight at about 25° C.

7. A detergent composition according to claim 1 wherein the hydrophobic block copolymer has a CLogP value of greater than about 1 and less than about 40.

8. A detergent composition according to claim 1 wherein the hydrophobic block copolymer comprises more than about 5% but less than about 50% ethylene oxide moieties.

9. A detergent composition according to claim 1 additionally comprising at least about 25% surfactant.

10. A detergent composition according to claim 9 comprising at least about 30% surfactant.

11. A process of washing dishware by contacting said dishware with a composition according to claim 1.
